(19) United States
(12) Patent Application Publication
(10) Pub. No.: US 2003/0164409 A1
(43) Pub. Date: Sep. 4, 2003

(54) Fluid mixing apparatus

(75) Inventors: Toshikazu Ohnishi, Kyoto (JP); Yoshiyuki Sawada, Kyoto (JP); Seiichi Taniguchi, Kyoto (JP); Yoshimi Matsuura, Kyoto (JP)

Correspondence Address: SUGHRUE MION, PLLC, 2100 PENNSYLVANIA AVENUE, N.W., WASHINGTON, DC, 20037, US

(73) Assignee: HORIBA, LTD.

(21) Appl. No.: 10/086,423

(22) Filed: Mar. 4, 2002

(51) Int. Cl. B05B 7/12

(52) U.S. Cl. 239/413

(57) ABSTRACT

A fluid mixing apparatus that mixes a plurality of fluids and switches between supply and stop of these fluid, which is able to reduce the degree of retention of the fluid and mix the fluid smoothly. Even in the case where the flow rate of another fluid is larger than the flow rate of the one fluid or even in the case where the fluid is repeatedly supplied and stopped, since a tip end of a nozzle provided at a fluid exhausting portion of the switching valve is disposed at a center portion of flow of the one fluid, another fluid and the one fluid can be mixed quickly with a simple configuration.

### BACKGROUND OF THE INVENTION

The present invention relates to a fluid mixing apparatus that mixes a plurality of fluids and changes between supply and stop of these fluids.

In general, the process of mixing a plurality of fluids has been employed in various fields such as chemical industry. In the case of mixing two fluids, usually, when respective pipes for the two fluids are coupled simply as shown in FIG. 3A, the concentration of the mixed fluid becomes uniform. Further, even in the case of joining and mixing a single flow of fluid with a plurality of fluid, the object can be attained sufficiently with such a configuration shown in FIG. 3B. In particular, when fluid is gaseous body, the fluid diffuses easily, so that, in general, a particular method is scarcely employed in order to mix gaseous bodies.

However even in the aforesaid cases, when it is desired to form a sufficient mixed state in a short time or when fluid can not be mixed sufficiently under a flow rate condition described later, such methods have been employed that a predetermined space (hereinafter called a buffer) is provided in a flow path at the rear stage of a mixing portion, or a part of the flow path is expanded or shrunk or repeatedly expanded and shrunk, or barriers are provided at the flow path. Each of the methods is employed mainly in view of making the flow of the fluid to be mixed a turbulent flow thereby to facilitate the mixing operation. FIGS. 4A to 4C show simplified diagrams of these methods.

In general, in the case of controlling supply and stop of each fluid, in most cases there has been employed a method of providing a switching valve on the upstream side of each mixing point and instructing the open or closed state of each of the switching valves from the outside. In this case, as shown in FIG. 5, there has been frequently employed a method of forming a flow path pattern in a block and providing a switching valve 22 on the block 50 thereby to save a space, realize hybrid and realize high-speed responsibility. In this respect, one fluid from a flow path a and another fluid from a flow path b are introduced and mixed at a mixing portion 24 and the mixed fluid is exhausted from an output port OUT.

FIG. 6A shows an example of a state where a switching valve 62 is attached to a block 61. FIG. 6B shows bottom view. Although another fluid is introduced within the inner space 65 of the valve portion 64 of the main body of the switching valve 62 from the flow path b in FIG. 5, when the switching valve 62 is in an open state shown in FIG. 6D, the another fluid is discharged from a fluid exhausting path 63 through a space generated between the valve portion 64 and a seal portion 66. In contrast, when the switching valve is in a closed state shown in FIG. 6C, the another fluid is cut off at the valve portion 64. When the switching valve 62 is in the open state shown in FIG. 6D, the another fluid is exhausted with respect to the one fluid flow from a flow path provided within a block communicating with the fluid exhausting path 63 and so these fluid start mixing.

However, in the case of applying a fluid mixing apparatus using the conventional technique to the aforesaid field, it was required to overcome the following problems.

When the flow rate or flow velocity of the another fluid is higher by a predetermined value than that of the one fluid, a part of the flow of the one fluid from the switching valve exhausting port may be in a blocked state or may be kept in a state of partially forming a laminar flow, whereby there arises a case where the one flow is hardly mixed or is not mixed with the another flow.

The inventors of the present invention have confirmed by an experiment that, in the case where the flow path of the another fluid is such a fine tube with an inner diameter of 4 mm, for example, such a phenomenon occurs when the flow rate of the another fluid is ten times or more the flow rate of the one fluid.

FIG. 6D schematically shows a state in this case. That is, this figure shows a state where the one fluid is taken into a layer forming the laminar flow of the another fluid and prevented from being diffused. In an extreme case, there may arise a state that the fluid is scarcely exhausted from the fluid exhausting path.

The aforesaid phenomenon likely occurs when the fluid is repeatedly supplied and stopped. In particular, immediately after changing from the stop to the supply of the fluid, there may arise a case that it takes a quite long time to reach a steady state. In an extreme case, there may arise a case where a state is continued that the one fluid can not be supplied due to the presence of the flow of the another fluid.

In the former case, as described above, it is commonly performed to provide a buffer etc. as shown in FIG. 4. However, the addition of such buffers in the flow path is contrary to the intensiveness of functions and space saving caused by putting the buffers etc. together and also contrary to the tendency of increasing a response speed.

### SUMMARY OF INVENTION

In order to solve the aforesaid problem, the fluid mixing apparatus according to the invention has the following features.

The invention relates to a fluid mixing apparatus which controls supply of a plurality of fluids to mix the fluids, comprising: a valve connected to a nozzle to control supply of another fluid to the flow of one fluid; and said nozzle, a tip end of which is disposed at a center portion of flow of said one fluid.

When using the apparatus with such a feature, the another fluid can be exhausted smoothly from the tip end of the nozzle, and the another fluid and the one fluid can be mixed quickly with a simple configuration.

Preferably, in the apparatus having the aforesaid feature described above, the flowing direction of the fluid supplied from the nozzle is same as the flowing direction of the one fluid and there is a predetermined angle therebetween.

When using the apparatus with such a feature, it becomes possible to exhaust smoothly the another fluid from the tip end of the nozzle in a state of hardly being influenced by the pressure of the one fluid, so that the another fluid and the one fluid can be mixed quickly with a simple configuration.

Preferably, in the apparatus having the aforesaid feature described above, the direction of the nozzle inserted within the flow of the one fluid is perpendicular to the flowing direction of the one fluid.

When using the apparatus with such a feature, the another fluid smoothly exhausted from the tip end of the nozzle is caught in the Karman's vortex etc. generated by the nozzle, so that the another fluid and the one fluid can be mixed quickly with a simple configuration.

According to the second aspect of the invention, it is provided a standard gas generator which mixes a plurality of gases, comprising: a first gas path in which a first gas flows; a first flow controller provided in the first gas path, which controls flow rage of the first gas; a first gas valve provided in the first gas path, which allows and stops the first gas to flow in the first gas path; a second gas path in which a second gas flows; a second flow controller provided in the second gas path, which controls flow rage of the second gas; a second gas valve provided in the second gas path, which allows and stops the second gas to flow in the second gas path, said second gas valve being connected to a nozzle; and said nozzle connected to said second gas path, a tip end of which is disposed at a center of said first gas path.

### BRIEF DESCRIPTION OF THE DRAWINGS

FIGS. 1A to 1D are explanatory diagrams showing the implementation method of the invention;

FIG. 2 is an explanatory diagram showing an example of a standard gas generating apparatus utilizing the invention;

FIGS. 3A and 3B are explanatory diagrams showing the conventional implementation method;

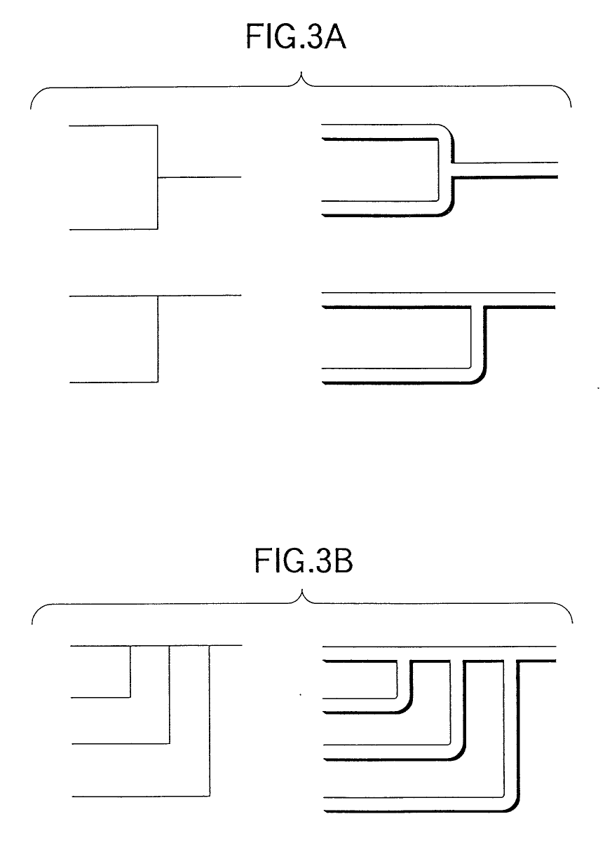

FIGS. 4A to 4C are explanatory diagrams showing the conventional implementation method;

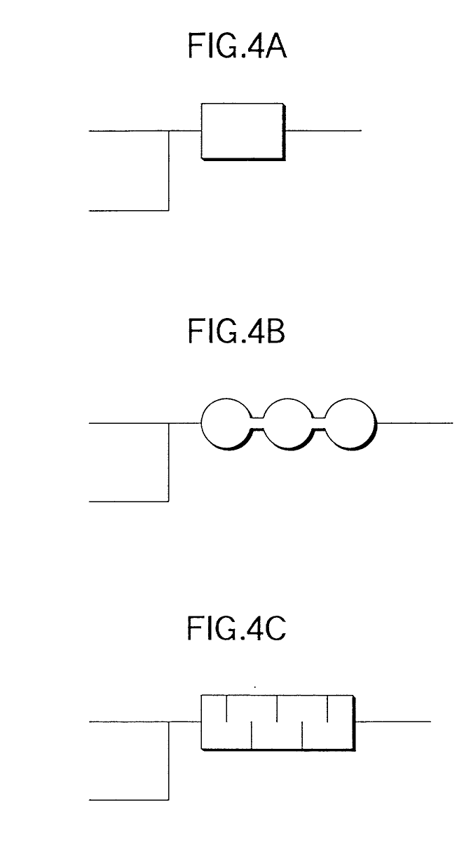

FIG. 5 is an explanatory diagram showing an embodiment of a flow path pattern; and

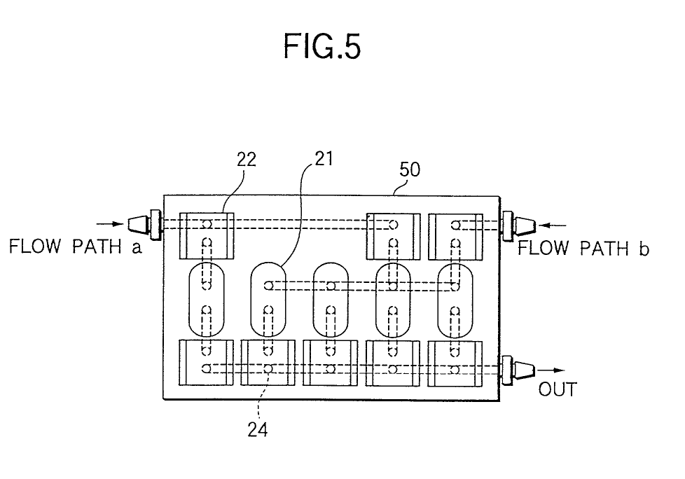

FIGS. 6A to 6D are explanatory diagrams showing the conventional implementation method.

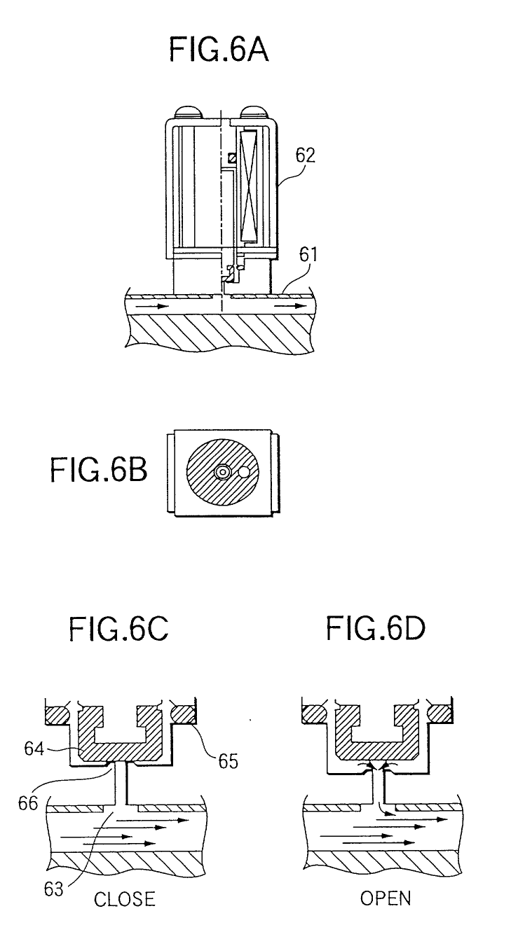

### DETAILED DESCRIPTION OF THE PREFERRED EMBODIMENTS

The embodiment of the invention will be explained with reference to the drawings showing a concrete example.

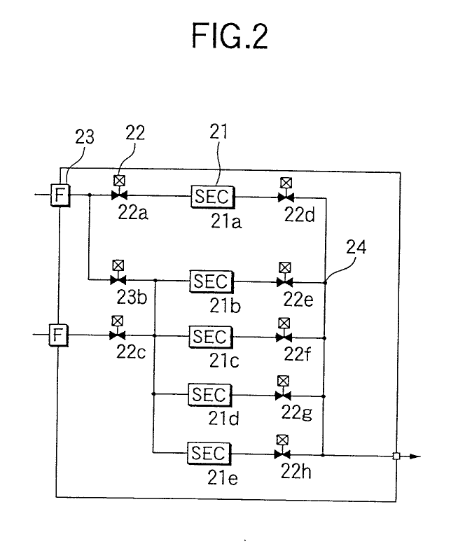

FIG. 2 shows a standard gas generating apparatus which is one of concrete embodiments of an apparatus using the invention for switching between the supply and stop of a plurality of fluids and mixing these fluids.

Reference gas A and subject gas B are mixed at a constant ratio by using a part or the entirety of massflow controllers 21 in which plural kinds of flow rates are set in advance thereby to generate a mixed gas (hereinafter called “standard gas”). FIG. 2 shows an example where four massflow controllers for subject gas (21b to 21e) are disposed.

To be more concrete, each of switching valves 22a and 22d is set in an open state, and the reference gas A is introduced into a massflow controller 21a through a filter 23. Then, in the case of supplying the subject gas B by using a single massflow controller, each of switching valves 22c and 22e is set in an open state and the subject gas is introduced into the massflow controller 21b through the filter 23. Both the gases are aggregated and mixed at a point 24 and exhausted out of a mixing apparatus 20 as standard gas C. When the massflow controllers 21 are set at predetermined flow rates in advance, respectively, it is possible to select the massflow controllers 21 in accordance with a flow rate necessary for generating standard gas. That is, when the four kinds of mass flow controllers are prepared as shown in FIG. 2, it is possible to generate standard gases with 16 kinds of concentrations in total based on one and the combination of these massflow controllers.

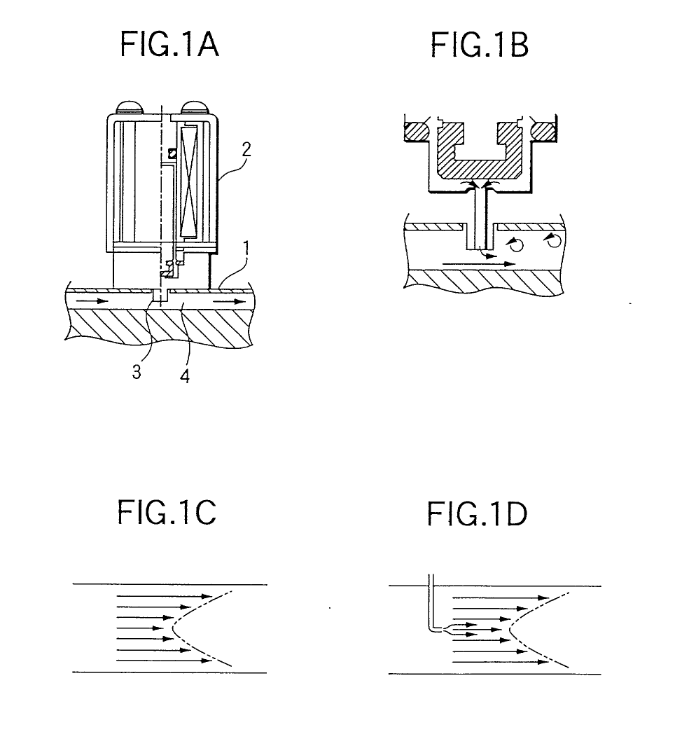

FIGS. 1A to 1D show one of the concrete embodiments of the invention. That is, this figure shows a state where a switching valve 2 is attached to a pipe arrangement block 1 at the mixing point in FIG. 2.

As shown in FIG. 1A, a nozzle portion 3 is provided at the fluid exhausting portion of the switching valve 2 for supplying and stopping another fluid, that is, the subject gas B, and the tip end 4 of the nozzle portion is disposed at the center portion of the flow of the aforesaid one fluid, that is, the reference gas A.

In general, when the fluid flows within a flow path having a constant tubular diameter at a predetermined flow rate, the flow rate becomes minimum at the center portion of the tube and the flow rate becomes quite large at the portion near the wall of the tube, as shown in FIG. 1C. In this respect, the lengths of arrows show flow rates at the positions within the tube, respectively. Thus, when the subject gas B is injected at the center portion of the flow of the reference gas A, the ratio of the flow rates between the reference gas and the subject gas can be reduced to one several-th (a quarter or less) as compared with the case where the subject gas is injected at the wall of the tube.

Further, in this case, since the subject gas B is injected from the tip end 4 of the nozzle portion having a thinner inner diameter, the subject gas is blown out within the flow of the reference gas A with a quite large flow rate at the tip end portion of the nozzle portion.

Therefore, the ratio of the flow rates between the reference gas A and the subject gas B becomes quite small as compared with the case where the nozzle 3 is not employed, so that the blocked state of the subject gas B at the switching valve exhausting port and the insufficient mixture with the reference gas A can be prevented from being generated. Thus, the fluid can be exhausted smoothly from the tip end 4 of the nozzle portion and so the gases can be mixed smoothly. FIG. 1B shows a mixed state of the reference gas A and the subject gas B in the open state of the switching valve 2.

To be more concrete, it has been proved from the experiments of the inventors that in the case of flowing the reference gas A at a flow rate of 4L/min within a tube having an inner diameter of 4 mm and injecting the subject gas B therein at a flow rate of 8 mL/min, these gases can be mixed quite well when the inner diameter of the nozzle is 2 mm or less.

FIG. 1A shows a case where the flowing direction of the subject gas B supplied from the nozzle 3 is perpendicular to the flowing direction of the reference gas A. However, effect similar to the aforesaid effect can be attained also in the case where the flowing direction of the subject gas is same as that of the reference gas A and also in the case where there is a predetermined angle between the flowing direction of the subject gas and that of the reference gas.

That is, even if the nozzle 3 is provided at the center of the flow of the fluid to be mixed, when the flowing direction of the subject gas B is made coincide with the flowing direction of the reference gas A as shown in FIG. 1D, the subject gas B and the reference gas A near the subject gas likely become a laminar flow state when the flow rate of the reference gas A is quite large. Thus, there may arise a state similar to the aforesaid problem of the invention.

In this case, when the flow of the subject gas B flown from the nozzle 3 is set to have a constant angle with respect to the flow of the reference gas A, such a state can be broken and so the both gases can be mixed easily.

When the nozzle 3 is disposed so as to be perpendicular to the flowing direction of the reference gas A, it is known that Karman's vortex, for example, is generated within the tube on the downstream side of the nozzle 3. According to the invention, such subject gas B blown out from the tip end 4 of the nozzle portion moves in a manner that the subject gas is caught in the Karman's vortex immediately after being blown out from the tip end, and so a kind of turbulence state is generated. Thus, the reference gas is likely mixed with the subject gas B and the gases can be mixed quite quickly.

The aforesaid function is particularly effective at the time of shifting the switching valve from the closed state to the open state. That is, in the closed state, the reference gas A is in a state similar to the laminar flow near the tip end of the nozzle, and a state is maintained that the flow rate is larger at the surface of the tip end portion of the nozzle as compared with the portion near the tip end portion. The large flow rate of the subject gas B from the nozzle serves to break such a state, and so the subject gas B can be injected into the flow of the reference gas A and the both gases can be mixed easily.

When using the apparatus having the aforesaid features, another fluid can be exhausted smoothly from the tip end of the nozzle. Further, even in the case where the flow rate of the another fluid is larger than the flow rate of the one fluid or even in the case where the fluid is repeatedly supplied and stopped, the another fluid and the one fluid can be mixed quickly with a simple configuration.

What is claimed:

1. A fluid mixing apparatus which controls supply of a plurality of fluids to mix the fluids, comprising:
a valve connected to a nozzle to control supply of another fluid to the flow of one fluid; and
said nozzle, a tip end of which is disposed at a center portion of flow of said one fluid.

2. A fluid mixing apparatus according to claim 1, wherein a flowing direction of the fluid supplied from the nozzle is same as a flowing direction of the one fluid.

3. A fluid mixing apparatus according to claim 1, wherein a direction of the nozzle inserted within flow of the one fluid is perpendicular to a flowing direction of the one fluid.

4. A standard gas generator which mixes a plurality of gases, comprising:
a first gas path in which a first gas flows;
a first flow controller provided in the first gas path, which controls flow rage of the first gas;
a first gas valve provided in the first gas path, which allows and stops the first gas to flow in the first gas path;
a second gas path in which a second gas flows;
a second flow controller provided in the second gas path, which controls flow rage of the second gas;
a second gas valve provided in the second gas path, which allows and stops the second gas to flow in the second gas path, said second gas valve being connected to a nozzle; and
said nozzle connected to said second gas path, a tip end of which is disposed at a center of said first gas path.
